(19) United States
(12) Patent Application Publication
(10) Pub. No.: US 2012/0088493 A1
(43) Pub. Date: Apr. 12, 2012

(54) WALLMOUNT REMOTE CONTROL INTEGRATING REMOTE CONTROL FUNCTION OF AN INTELLIGENT CELLULAR PHONE

(76) Inventors: Wan-Tien Chen, Taipei (TW); Wei-Cheng Lin, Taipei (TW)

(21) Appl. No.: 13/251,196

(22) Filed: Sep. 30, 2011

(30) Foreign Application Priority Data
Oct. 7, 2010 (TW) 099134209

(51) Int. Cl. H04W 88/02

(52) U.S. Cl. 455/419

(57) ABSTRACT

A wallmount remote control integrating remote control function of an intelligent cellular phone has a body, a phone holder and a transmission connector. The body has a circuit unit and an input unit and a power supply unit electrically connected with the circuit unit. The phone holder serves to accommodate a cellular phone therein. The transmission connector is mounted on the phone holder, is electrically connected with the power supply unit and the circuit unit, and can be connected with a transmission port of a cellular phone to transmit data and power from the cellular phone. When an intelligent cellular phone is inserted in the wallmount remote control, the input function of the wallmount remote control is disabled and the cellular phone replaces the wallmount remote control to remotely control the household appliance. When the cellular phone is removed, the wallmount remote control is enabled to perform its original input function.

### BACKGROUND OF THE INVENTION

1. Field of the Invention

The present invention relates to a remote control, and more particularly to a remote control capable of being wallmounted and integrating remote control function of an intelligent cellular phone.

2. Description of the Related Art

Wide-ranging penetration of electric appliances into all walks of life improves standard of life and gives consumers diversified choices upon shopping. To attract consumers' desire to purchase, manufacturers of electric appliances constantly develop and introduce new products to the market. Besides high quality and low price, electric appliances tend to be designed with particular functions and to be multi-functional as the selling points. For example, regular electric appliances come with a remote control, allowing users to press buttons on the remote control to remotely control electric appliance within a signal accessible distance. As a result, users can remotely control electric appliances without having to go near electric appliances in order to press buttons thereon, thereby increasing the operational convenience.

However, the remote controls coming with the electric appliances have merely the plain function of remote control, limited in the scope of function. To attract consumers and be more competitive in the market, conventional remote controls need to be further improved with more add-on value.

### SUMMARY OF THE INVENTION

An objective of the present invention is to provide a wallmount remote control integrating remote control function of an intelligent cellular phone.

To achieve the foregoing objective, the wallmount remote control has a body, a phone holder and a transmission connector.

The body has a front surface, a circuit unit, an input unit, a switching unit and a power supply unit. The circuit unit is mounted inside the body and has a microprocessor, and a transmission module and a wireless communication module electrically connected with the microprocessor. The input unit is electrically connected with the circuit unit and the microprocessor, is mounted on a front surface of the body, and is enabled to be in an operating mode and disabled to be in an idle mode. The switching unit is triggered to generate and transmit a switching signal to the microprocessor for the microprocessor to switch a current operating mode of the input unit according to the switching signal. The power supply unit is mounted inside the body for supplying an operating power of all foregoing units.

The phone holder has a stopper and two arms formed on and protruding forwardly from the front surface.

The transmission connector is mounted on the stopper, and is electrically connected with the transmission module of the circuit unit and the power supply unit to acquire power through the power supply unit and perform data communication with the microprocessor through the transmission module.

The transmission connector is electrically connected with the power supply unit and the circuit unit, and can be connected with a transmission port of a cellular phone to transmit power from and perform data communication with the cellular phone. The wallmount remote control serves as a regular remote control to remotely control a corresponding household appliance when there is no cellular phone inserted therein, while the function of the wallmount remote control is disabled and the cellular phone replaces the wallmount remote control to remotely control the household appliance when the cellular phone is inserted therein. The wallmount remote control achieves to be multi-functional and integrate the remote control function of the cellular phone inserted therein.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a wallmount remote control integrating remote control function of an intelligent cellular phone in accordance with the present invention;

FIG. 2 is a functional block diagram of the wallmount remote control in FIG. 1;

FIG. 3 is an operational perspective view of the wallmount remote control in FIG. 1 before a cellular phone is mounted in the wallmount remote control;

FIG. 4 is another operational perspective view of the wallmount remote control in FIG. 1 when a cellular phone is mounted in the wallmount remote control;

FIG. 5 is a perspective view of a second embodiment of a wallmount remote control integrating remote control function of an intelligent cellular phone in accordance with the present invention;

FIG. 6 is an operational perspective view of the wallmount remote control in FIG. 5 before a cellular phone is mounted in the wallmount remote control; and

FIG. 7 is a perspective view of a third embodiment of a wallmount remote control integrating remote control function of an intelligent cellular phone in accordance with the present invention.

### DETAILED DESCRIPTION OF THE INVENTION

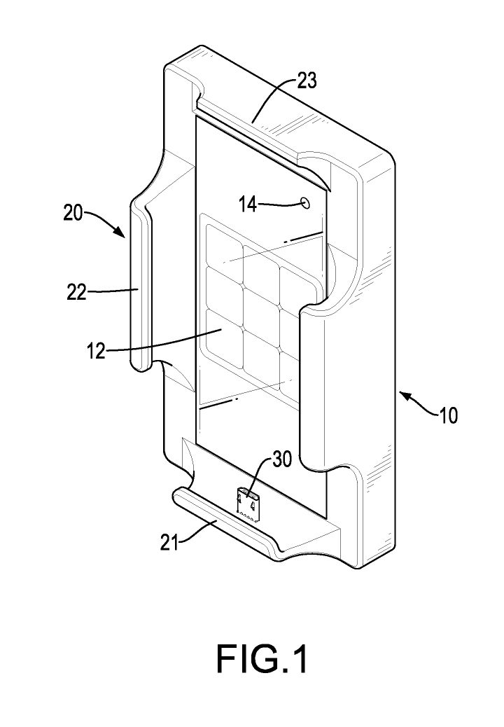

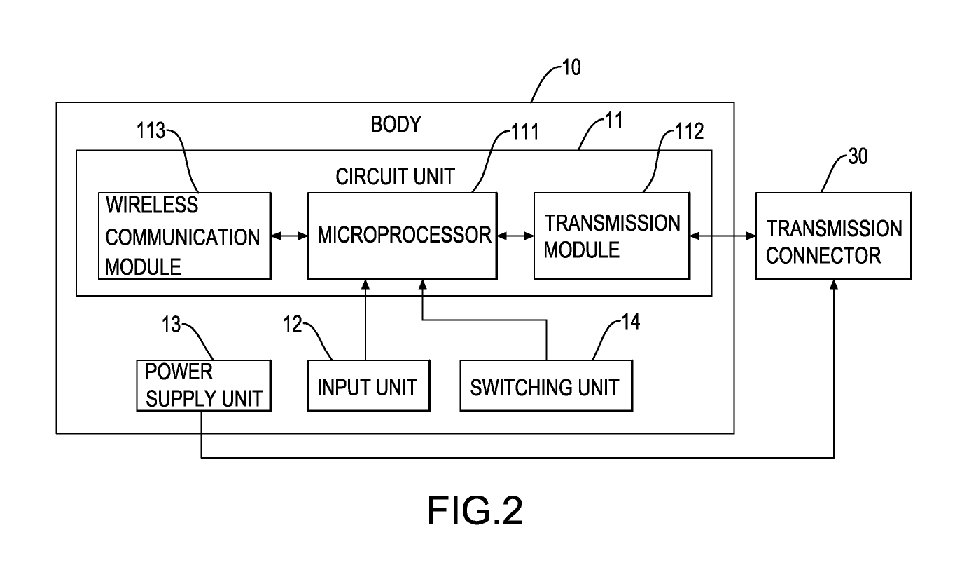

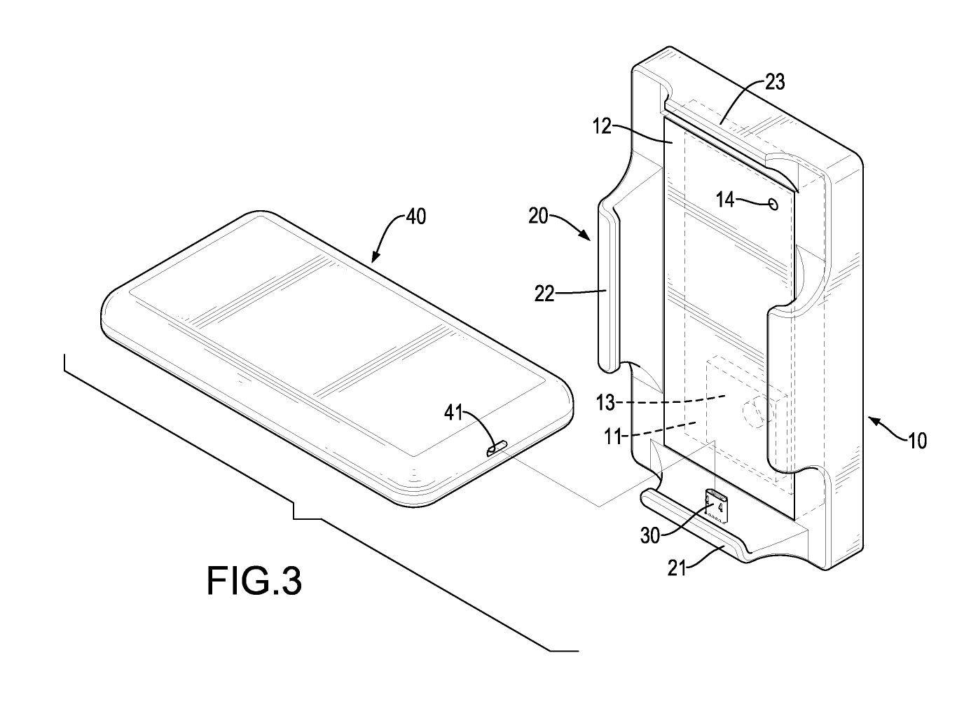

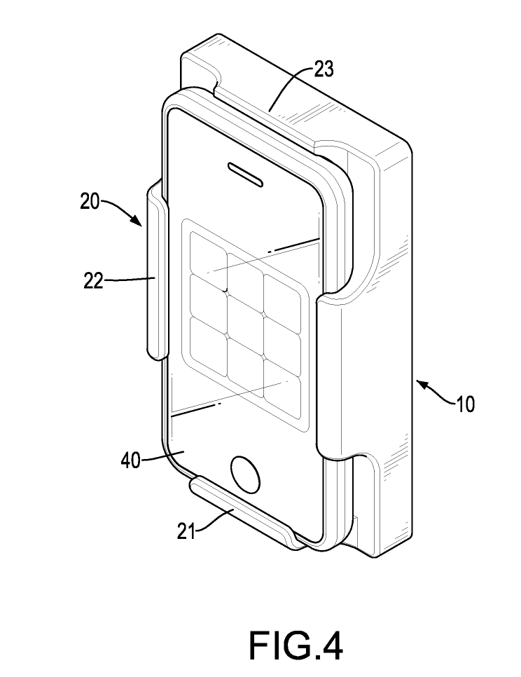

With reference to FIGS. 1 to 4, a first embodiment of a wallmount remote control integrating remote control function of an intelligent cellular phone in accordance with the present invention has a body 10, a phone holder 20 and a transmission connector 30.

The body 10 is flat and rectangular, and a rear of the body 10 is mounted on a wall. The body has a circuit unit 11, an input unit 12, a switching unit 14 and a power supply unit 13. The circuit unit 11 is mounted inside the body 10 and has a microprocessor 111, a transmission module 112 and a wireless communication module 113. The transmission module 112 and the wireless communication module 113 are electrically connected with the microprocessor 111. The wireless communication module 113 complies with a wireless communication standard such as WiFi, Bluetooth, Zigbee, infrared communication or the like. The input unit 12 is electrically connected with the circuit unit 11, is mounted on a front surface of the body 10, and is electrically connected with the microprocessor 111. The switching unit 14 is mounted on the front surface of the body 10, and is electrically connected with the microprocessor 111 of the circuit unit 11. Upon detecting luminance variation, the switching unit 14 generates a switching signal to the microprocessor 111 and the microprocessor 111 enables or disables the input unit 12 according to the switching signal. The power supply unit 13 is mounted inside the body 10 for supplying operating power to the circuit unit 11, the input unit 12 and the switching unit 14. In the present embodiment, the input unit 12 is a touch screen, the switching unit 14 is at least one photo sensor, and the power supply unit 13 is a power converter electrically connected with power lines inside a wall so as to acquire required power from the AC mains.

The phone holder 20 is formed around a perimeter of the body 10 and has a stopper 21, two arms 22 and a slide-in end 23. To accommodate a cellular phone having a connection port mounted on a bottom of the cellular phone, the stopper 21 is mounted on a bottom of the body 10. The arms 22 are respectively formed on and protrude from two opposite sides of the body 10. The slide-in end 23 is formed on a top of the body 10. The stopper 21, the arms 22 and the slide-in end 23 are formed around the perimeter of the body and protrude forwardly to hold a cellular phone 40 slid through the slide-in end 23 so that the stopper 21 abuts against a bottom of the cellular phone 40 and the arms 22 respectively hold two opposite sides of the cellular phone 40. As the switching unit 14 is adjacent to the slide-in end 23 and is situated on a slide-in path of the cellular phone 40, the switching unit 14 is covered by the cellular phone 40. The cellular phone 40 may have a touch screen or a key input device as an input device.

The transmission connector 30 is mounted on a top of the stopper 21, and is electrically connected with the transmission module 112 of the circuit unit 11 and the power supply unit 13. The transmission connector 30 can be connected with a transmission port 41 mounted on a bottom of the cellular phone 40 so that the cellular phone 40 can acquire power and perform full duplex data communication with the microprocessor 111 through the transmission connector 30, the power supply unit 13 and the transmission module 113.

The wallmount remote control is provided to charge and accommodate the cellular phone 40. As the wallmount remote control can be mounted on a wall and connected with the power lines inside the wall, it is convenient for the cellular phone 40 to be charged through the wallmount remote control. Moreover, after the cellular phone 40 is inserted in the wallmount remote control, the transmission port 41 of the cellular phone 40 is connected with the transmission connector 30 and the cellular phone 40 covers the input unit 12 of the wallmount remote control. The microprocessor 111 of the circuit unit 11 disables the input unit 12 of the wallmount remote control to be idle and enables the input device of the cellular phone 40 to be active. Therefore, users can operate the remote control function provided by the cellular phone 40 instead.

The activation and deactivation of the input device of the cellular phone 40 is described as follows. When the cellular phone 40 is inserted in the wallmount remote control, the switching unit 14 is blocked from light. The switching unit 14 generates and transmits a switching signal to the microprocessor 111 to inform the microprocessor 111 to disable the input unit 12 to be idle and enable the input device of the cellular phone 40 to be active, thereby allowing users to input commands to remotely controlled household appliances through the cellular phone 40. After the cellular phone 40 is removed from the wallmount remote control, the switching unit 14 senses light variation again and the switching unit 14 generates and transmits a switching signal to the microprocessor 111 to inform the microprocessor 111 to enable the input unit 12 to be active.

The wallmount remote control can further employ individual function and combine functions of various software downloaded from the Internet, and can further adopt a graphical user interface (GUI) as the interface of the input unit 12.

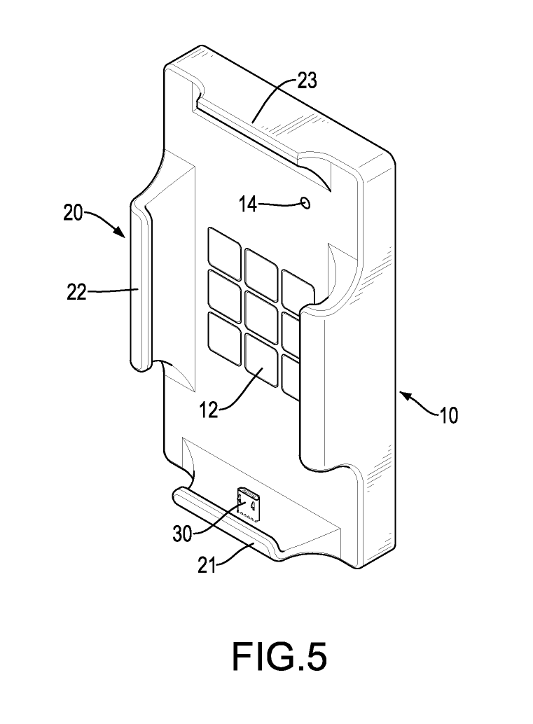

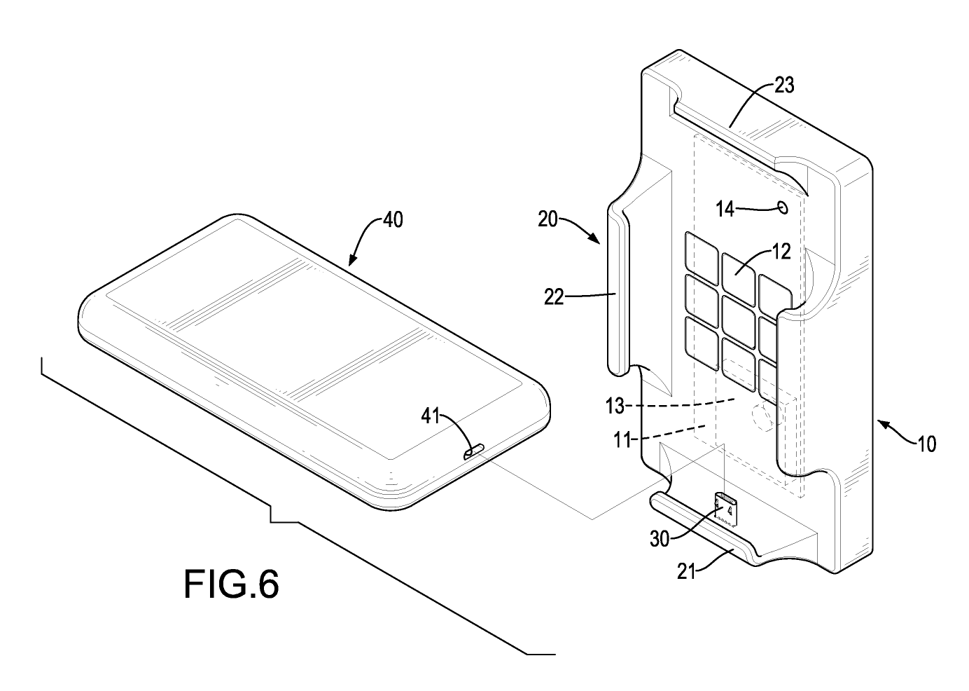

With reference to FIGS. 5 and 6, a second embodiment of a wallmount remote control integrating remote control function of an intelligent cellular phone in accordance with the present invention is similar to the first embodiment except that the switching unit 14 is replaced by at least one button instead of the at least one photo sensor. The switching unit 14 is mounted on the front surface of the body 10, and generates a switching signal to enable or disable the input unit 12 through the microprocessor 111 when the switching unit 14 is pressed. In the present embodiment, instead of being a touch screen, the input unit 12 is composed of multiple buttons.

The functions provided by the present embodiment are similar to those of the first embodiment. The only difference lies in that the switching unit 14 needs to be manually operated to generate and output a switching signal to the microprocessor 111 before the cellular phone 40 is inserted in the wallmount remote control. The switching signal informs the microprocessor 111 to disable the input unit 12. Meanwhile, the cellular phone 40 is enabled to replace the input unit 12 so as to allow users to input commands for remotely controlled household appliances through the cellular phone 40. After the cellular phone 40 is removed, users must manually press the switching unit 14 to generate and transmit a switching signal to the microprocessor 111. The switching signal informs the microprocessor 111 to enable the input unit 12 to be active.

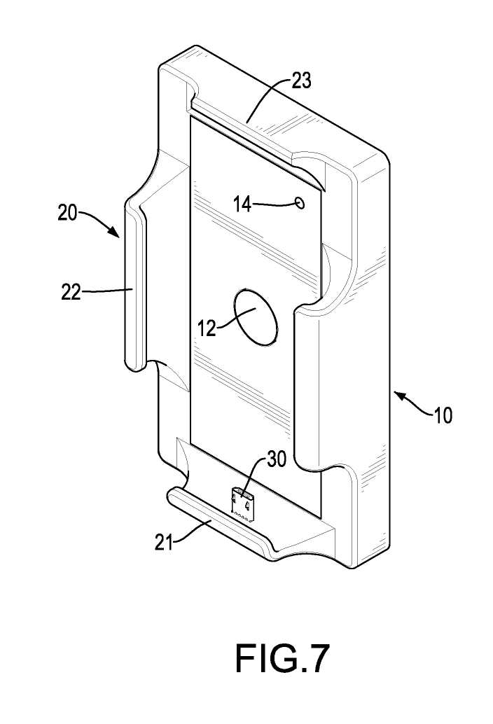

With reference to FIG. 7, a third embodiment of a wallmount remote control in accordance with the present invention is similar to the first embodiment except the input unit 12. The input unit 12 in the present embodiment is a rotary knob mounted on the front surface of the body 10. When the input unit 12 is pressed, the input unit 12 generates and transmits a switching signal to the microprocessor 111. The microprocessor 111 further enables or disables the input unit 12 according to the switching signal.

The functions provided by the present embodiment are similar to those of the first embodiment. The only difference lies in that users must manually press the input unit 12 to generate and transmit a switching signal to the microprocessor 111 before the cellular phone 40 is inserted in the wallmount remote control. The microprocessor 111 then disables the input unit 12 to be idle according to the switching signal, and the cellular phone 40 is enabled to replace the input unit 12 so as to input commands for remotely controlled household appliances through the cellular phone 40. After the cellular phone 40 is removed, users must manually press the input unit 12 again to generate and transmit a switching signal to the microprocessor 111. The microprocessor 111 then enables the input unit 12 to be active according to the switching signal, and the input unit 12 replaces the cellular phone 40 to input commands for remotely controlled household appliances.

With the phone holder 20 and the transmission connector, the wallmount remote control integrating remote control function of an intelligent cellular phone can serve as both a phone holder and a charger. Additionally, when a cellular phone is inserted in the wallmount remote control, the input unit 12 of the wallmount remote control is disabled and the input device of the cellular phone replaces the input unit 12 of the wallmount remote control to perform input function. After the cellular phone is removed from the wallmount remote control, the input unit 12 of the wallmount remote control is enabled to be active and the wallmount remote control serves as a regular remote control. Accordingly, the wallmount remote control addresses a multi-functional solution serving to charge and store a cellular phone on a wall and integrate input function of a cellular phone.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A wallmount remote control integrating remote control function of an intelligent cellular phone, comprising:
a body having:
a front surface;
a circuit unit mounted inside the body and having a microprocessor, and a transmission module and a wireless communication module electrically connected with the microprocessor;
an input unit electrically connected with the microprocessor, mounted on the front surface of the body;
a switching unit mounted on outside the body and electrically connected with the microprocessor to generate and transmit a switching signal to the microprocessor if the switching unit is triggered, so the microprocessor enables or disables the input unit according to the switching signal; and
a power supply unit mounted inside the body for supplying an operating power to the circuit unit, the input unit and the switching unit;
a phone holder having a stopper and two arms formed on and protruding forwardly from the front surface; and
a transmission connector mounted on the stopper, and electrically connected with the transmission module of the circuit unit and the power supply unit for power and data transmission.

2. The wallmount remote control as claimed in claim 1, wherein the switching unit is at least one photo sensor for detecting luminance variation.

3. The wallmount remote control as claimed in claim 1, wherein the switching unit is at least one button.

4. The wallmount remote control as claimed in claim 1, wherein the input unit is a touch screen.

5. The wallmount remote control as claimed in claim 2, wherein the input unit is a touch screen.

6. The wallmount remote control as claimed in claim 3, wherein the input unit is a touch screen.

7. The wallmount remote control as claimed in claim 1, wherein the input unit comprises multiple buttons.

8. The wallmount remote control as claimed in claim 2, wherein the input unit comprises multiple buttons.

9. The wallmount remote control as claimed in claim 3, wherein the input unit comprises multiple buttons.

10. The wallmount remote control as claimed in claim 1, wherein the input unit is a rotary knob.

11. The wallmount remote control as claimed in claim 2, wherein the input unit is a rotary knob.

12. The wallmount remote control as claimed in claim 3, wherein the input unit is a rotary knob.

13. The wallmount remote control as claimed in claim 1, wherein the wireless communication module complies with WiFi wireless communication standard.

14. The wallmount remote control as claimed in claim 2, wherein the wireless communication module complies with WiFi wireless communication standard.

15. The wallmount remote control as claimed in claim 1, wherein the wireless communication module complies with Bluetooth wireless communication standard.

16. The wallmount remote control as claimed in claim 2, wherein the wireless communication module complies with Bluetooth wireless communication standard.

17. The wallmount remote control as claimed in claim 1, wherein the wireless communication module complies with ZigBee wireless communication standard.

18. The wallmount remote control as claimed in claim 2, wherein the wireless communication module complies with ZigBee wireless communication standard.

19. The wallmount remote control as claimed in claim 1, wherein the wireless communication module complies with infrared communication standard.

20. The wallmount remote control as claimed in claim 2, wherein the wireless communication module complies with infrared communication standard.
